(19) United States
(12) Patent Application Publication
(10) Pub. No.: US 2005/0108527 A1
(43) Pub. Date: May 19, 2005

(54) Method and apparatus to provide secured link

(76) Inventors: Boris Ginzburg, Haifa (IL); Max Fudim, Kiryat Bialik (IL); Vladimir Kondratiev, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/705,983

(22) Filed: Nov. 13, 2003

(51) Int. Cl. H04L 9/00

(52) U.S. Cl. 713/168

(57) ABSTRACT

Briefly, a method and apparatus that may establish a secured direct link between a first station and a second station of wireless local area network. The establishment of this secured direct link may be done by an access point that may exchange protocol messages between the first station the second station and the access point.

### BACKGROUND OF THE INVENTION

In wireless local area networks (WLAN), for example, WLANs that are based on IEEE-802.11-1999 standard, a basic service set (BSS) may include a set of stations, which may communicate with one another. In Some WLANs, for example, the BSS may include two stations (STA) and an access point (AP). In some of those WLANs, a first station (STA1) or a second station (STA2) may communicate with the AP but not with one another.

IEEE-802.11e-2003 draft, is an extension of the IEEE 802.11-1999 standard that introduced a mechanism for data packets transfer between two stations (e.g. STA1 and STA2) in the BSS. This mechanism may be referred and/or termed as “direct link” or “side traffic”. However, the data packet that may be transferred according to the above described mechanism may not be transferred in a secured manner and the content of the data packets may be monitored by other stations of the WLAN.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system according to an exemplary embodiment of the present invention;

FIG. 2 is a block diagram of an access point according to an exemplary embodiment of the present invention;

FIG. 3 is a block diagram of a station according to an exemplary embodiment of the present invention; and

FIG. 4 is a flowchart of method to establish a secured communication link between at least two stations according to some exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as, for example, “processing,” “computing,” “calculating,” “determining,” “establishing”, “sending”, “exchanging” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage medium that may store instructions to perform actions and/or process, if desired.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although are not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

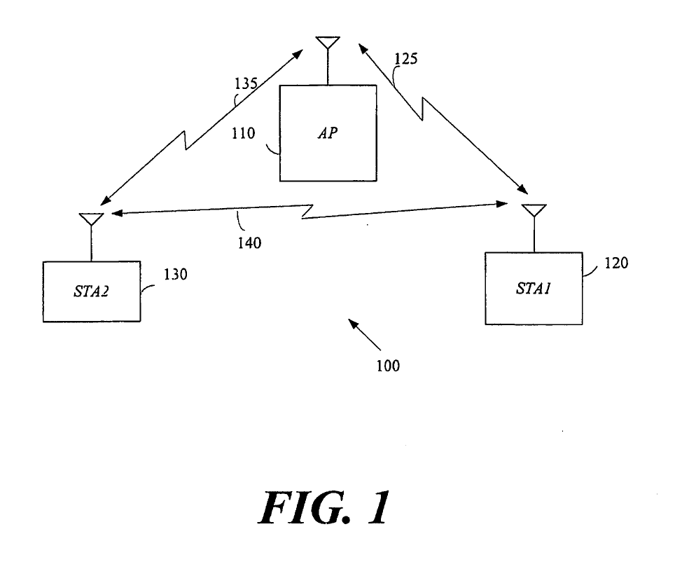

Turning first to FIG. 1, a wireless communication system 100, for example, a WLAN communication system is shown. Although the scope of the present invention is not limited in this respect, the exemplary WLAN communication system 100 may be defined, for example, by the IEEE 802.11-1999 standard, as a basic service set (BSS). For example, BSS may include at least one communication station, for example, an access point (AP) 110, a station 120 (STA1) and a station 130 (STA2). In some embodiments, station 120 and station 130 may transmit and/or receive one or more data packets over wireless communication system 100. The packets may include data, control messages, network information, and the like. Additionally or alternatively, in other embodiments of the present invention, wireless communication system 100 may include two or more APs and two or more mobile stations. This arrangement of wireless communication system 100 may be referred by the EEE 802.11-1999 standard as an extended service set (ESS), although the scope of the present invention is not limited in this respect.

Although the scope of the present invention is not limited in this respect, in some embodiments of the present invention station 120 may communicate with AP 110 via a link 125 and station 130 may communicate with AP 110 via a link 135. In addition, stations 120 and 130 may communicate with one another via a link 140. Although the scope of the present invention is not limited in this respect, link 140 may be a direct link.

Although the scope of the preset invention is not limited in this respect, STA1 120 and STA2 130 may communicate over link 140 to transfer data packets, for example, according to the IEEE 802.11e standard, if desired. In addition, STA1 120 and STA2 130 may communicate over link 140 to transfer the data packets in a secured fashion, which will be described in detail below. In embodiments of the present invention, the transportation of the data packets over link 140 in the secure fashion may be performed according to a secure direct link protocol (SDLP), if desired.

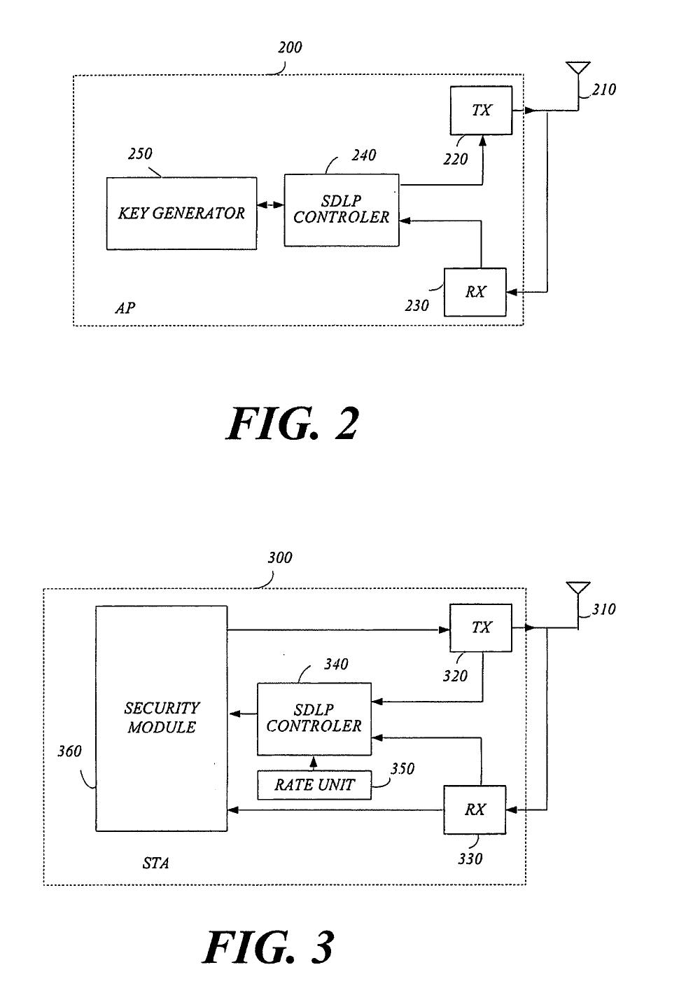

Turning to FIG. 2, a block diagram of an access point (AP) 200 according to some exemplary embodiments of the present invention is shown. Although the scope of the present invention is not limited in this respect, AP 200 may include an antenna 210, a transmitter (TX) 220 to transmit radio frequency (RF) signals, a receiver (RX) 230 to receive RF signals, a SDLP controller 240, and a key generator 250 to provide pair-wise keys to STA1 120 and STA2 130, if desired.

Although the scope of the present invention is not limited in this respect, antenna 210 may be an omni-directional antenna, a monopole antenna, a dipole antenna, an end fed antenna, a circularly polarized antenna, a micro-strip antenna, a diversity antenna, and the like.

Although the scope of the present invention is not limited in this respect, antenna 210 may receive RF signals, which may include SDLP messages and/or data packets from STA1 120 and/or STA2 130. RX 230 may demodulate the RF signals to receive the data packets and/or to process the SDLP messages and may transfer the SDLP messages to SDLP controller 240. SDLP controller 240 may generate response messages and may provide the response messages to TX 220. TX 220 may transmit the SDLP response messages via antenna 210 to STA1 120 and/or to STA2 130, if desired. In some embodiments of the present invention, the pair-wise keys may be used to encrypt the data packets that are transferred over link 140, if desired. The pair-wise keys may be provided by key generator 250.

Although the scope of the present invention is not limited in this respect, key generator 250 may generate the pair-wise keys according to a selected encryption method, for example, robust security network (RSN) methods such as, for example, temporal key integrity protocol (TKIP), and/or cipher block chaining (CBC) counter mode (CCM) and/or Wi-Fi protected access (WPA) methods, and the like. In embodiments of the invention, key generator 250 may generate pair-wise keys that may be used with the selected encryption method, if desired.

Turning to FIG. 3, a block diagram of a station (STA) 300 according to some exemplary embodiments of the present invention is shown. Although the scope of the present invention is not limited in this respect, STA 300 may include at least one antenna 310 that may be used to transmit and/or receive data packets over wireless communication system 100 (FIG. 1), for example, WLAN. In embodiments of the invention, antenna 310 may be an omni-directional antenna, a monopole antenna, a dipole antenna, an end fed antenna, a circularly polarized antenna, a micro-strip antenna, a diversity antenna and the like.

Although the scope of the present invention is not limited in this respect, STA 300 may include a transmitter (TX) 320, a receiver (RX) 330, a SDLP controller 340, a rate unit 350 that may store and provide at least one communication rate and/or a set of communication rates to SDLP controller, and a security module 360 to encrypt, decrypt and/or authenticate the data packets according to the selected security method. TX 320 and RX 330 may be used to transmit and/or receive packets over communication links, for example, link 140.

Although the scope of the present invention is not limited in this respect, SDLP controller 340 may receive information defining the communication rate from rate unit 350 and may receive information defining the security method from security module 360. In some embodiments of the present invention, SDLP controller 330 may provide and/or receive SDLP messages from an AP. For example, the SDLP message may include a request to establish a secured link, a response to the request or to requests, a “Success” message, an “Accept” message, or the like. Additionally or alternatively, the SDLP messages may include communication rate information, security method information, pair-wise keys, and the like. Although the scope of the present invention is not limited in this respect, SDLP controller 340 may include an application processor, a digital signal processor, a medium access controller, and the like. Additionally and/or alternatively, SDLP controller 340 may be implemented in software, in hardware and/or in combination of software and hardware.

Although the scope of the present invention is not limited in this respect, rate unit 350 may include a register and/or a memory, which may include the communication rate value and/or a plurality of other selectable communication rate values. In embodiments of the present invention, security module 360 may be implemented in software, in hardware, and/or in any suitable combination of software and hardware.

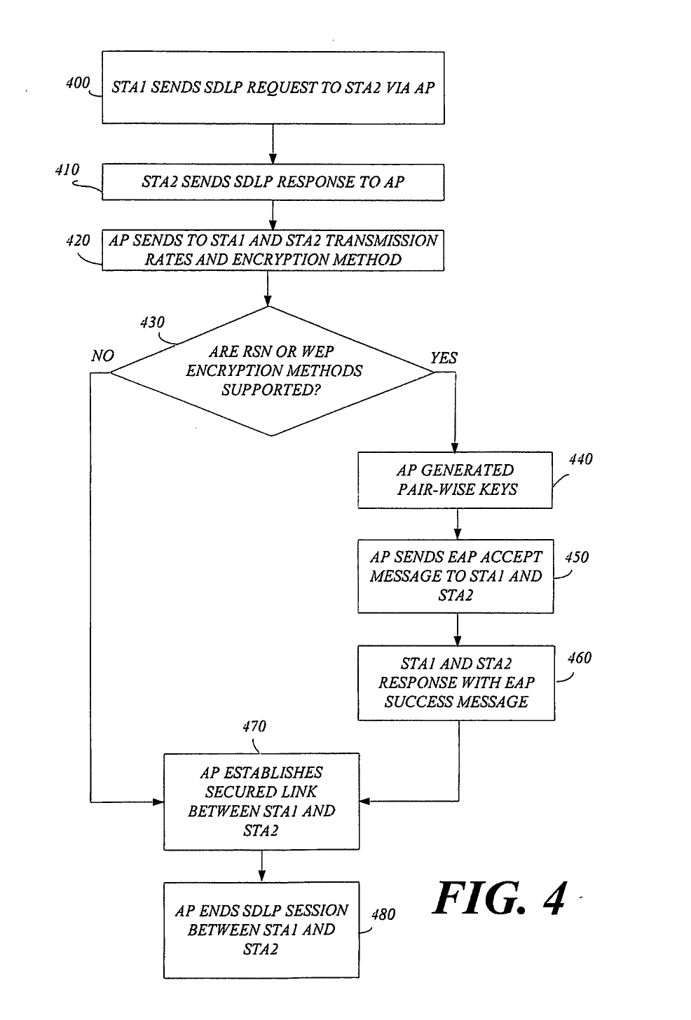

Turning to FIG. 4, a flowchart of method to establish a secured communication link between at least two stations according to some exemplary embodiments of the present invention is shown. Although the scope of the present invention is not limited in this respect, the exemplary method may begin with STA1 (e.g. station 120 of FIG. 1) may send a SDLP request to an AP, for example, AP 110 (box 400), for example, to establish a secured direct link with STA2 (e.g. station 130 of FIG. 1). For example, the SDLP request may include a SDLP message that may include medium access control (MAC) addresses of STA1 and STA2, a supported communication rate set of STA1 and a supported encryption method and/or methods of STA1, if desired. Although the scope of the present invention is not limited in this respect, in the SDLP message, STA1 may be referred to and/or defined as an initiator of the SDLP, STA2 may be referred and/or defined as a recipient, and the AP may be referred and/or defined as a mediator.

Although the scope of the present invention is not limited in this respect, the AP may send the SDLP request to STA2 and, in return, STA2 may send a response to the AP (box 410). The response may include information on the ability of STA2 to support the SDLP. In some embodiments of the present invention, STA2 may not support SDLP. In those embodiments, the AP may send a “Reject” message to STA1 in order to terminate an attempt to establish the SDLP link. In some other embodiments of the present invention, STA2 may support SDLP. In those embodiments, the AP (e.g. AP 110) may send to STA1 and STA2 SDLP messages, which may include the supported communication rate set and the supported encryption method and/or methods, although the scope of the present invention is limited in this respect (box 420). The AP, for example AP 110, may select a communication rate from a subset of communication rates supported by both stations, and may select a common encryption method that may be supported by both stations.

Although the scope of the present invention is not limited in this respect, in some embodiments, wherein the RSN encryption method and/or methods may not be supported by both stations, e.g., STA1 and STA2 (box 430) or an wired equivalent privacy (WEP) encryption, e.g. IEEE 802.11 encryption protocol, is supported by both STA1 and STA2, then the AP may establish a secured link between STA1 and STA2 (box 470). After the establishment of the secured link, the stations (e.g. STA1, STA2) may exchange data packets in a secured fashion, if desired.

Although the scope of the present invention is not limited in this respect, if both stations may support similar RSN encryption method, for example CCM, TKIP, or the like (box 430), then the AP may send a SDLP response to both stations. Such a response may include the subset of supported communication rates and the encryption method to be used between STA1 and STA2, for example, TKIP. In addition, the AP may exchange extensible authentication protocol (EAP) frames with STA1 and STA2 if desired.

In embodiments of the invention, an AP (e.g. AP 200 of FIG. 2) may generate pair-wise keys, for example, using key generator 250 (box 440) before the exchange of the EAP frames, if desired. In some embodiments, AP 200 may generate unicast TX and RX pair-wise keys that may be provided to STA1 and STA2. For example, STA1 may receive the MAC address of the STA2 and the unicast TX and RX pair-wise keys that may be generated according to the selected encryption method Furthermore, STA2 may receive the MAC address of the STA1 and the unicast TX and RX pair-wise keys that may be generated according to the selected encryption method. For example, AP 200 may send an “EAP accept” message that may include for example, the TX and RX pair-wise keys and the MAC address of STA2 or STA1, as desired (box 440). The stations (e.g. STA1 and STA2) may install the pair-wise keys and may respond to the AP with an “EAP success” message (box 460), if desired.

Although the scope of the present invention is not limited in this respect, the AP may establish the secured link by sending a “Ready” message to STA1 and STA2 (box 470). This may complete a handshake procedure between the AP and the stations. Subsequently, the stations (e.g. STA1, STA2) may exchange data packets in a secured fashion, if desired. When the data exchange is completed, the AP may send a “SDLP_End” message to STA1 and STA2 to end the SDLP session (box 480), if desired.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method comprising:
establishing a secured direct link between a first station and a second station of a wireless local area network by exchanging two or more protocol messages between an access point and the first station and the access point and the second station.

2. The method of claim 1, comprising:
receiving from the first station a request to establish the secured direct link, wherein the request includes communication rate information and encryption method information.

3. The method of claim 1, comprising:
receiving from the second station a request to establish the secured direct link, wherein the request includes communication rate information and encryption method information.

4. The method of claim 2, wherein establishing comprises:
sending to the second station a message to establish the secured direct link, wherein the message includes communication rate information of the first station and encryption method information of the first station.

5. The method of claim 3, wherein establishing comprises:
sending to the first station a message to establish the secured direct link, wherein the message includes communication rate information of the second station and encryption method information of the second station.

6. The method of claim 1 comprising:
selecting a supported communication rate from a set of communication rates.

7. The method of claim 6, wherein selecting comprises:
selecting the supported communication rate from a subset of said set of communication rates, wherein the rates in said subset are supported, at least in part, by both the first station and the second station.

8. The method of claim 1, comprising:
selecting an encryption method supported by both the first station and the second station; and
generating pair-wise keys according to the selected encryption method.

9. The method of claim 8, wherein generating comprises:
generating unicast pair-wise keys for encrypting a data packet; and
generating unicast pair-wise keys for decrypting the data packet.

10. The method of claim 8, wherein selecting the encryption method comprises:
selecting the encryption method from a group of robust security network encryption methods.

11. An apparatus comprising:
a controller to establish a secured direct link between a first station and a second station of wireless local area network by exchanging two or more protocol messages with the first station and the second station.

12. The apparatus of claim 11, wherein the controller is able to receive from the first station a request to establish the secured direct link, the request including a first set of communication rates and at least a type of at a supported encryption method, and wherein the controller is further able to generate a response message that includes at least a second set of communication rates and the type of the supported encryption method based on information received from the second station.

13. The apparatus of claim 12, wherein the controller is able to select from the first set of communication rates and the second set of communication rates a subset of communication rates that are supported by the first station and by the second station.

14. The apparatus of claim 12 wherein the controller is able to select an encryption method that is supported by the first station and the second station based on the supported type of the encryption method.

15. The apparatus of claim 14 comprising a key generator to generate pair-wise keys according to the encryption method.

16. The apparatus of claim 15, wherein the controller is able to generate two or more response messages that include a subset of communication rates and the pair-wise keys.

17. The apparatus of claim 17, comprising a transmitter to transmit the response messages to the first station and to the second station.

18. An apparatus comprising:
a dipole antenna to receive and transmit two or more protocol messages; and
a controller to establish a secured direct link between a first station and a second station of wireless local area network by exchanging the two or more protocol messages with the first station and the second station.

19. The apparatus of claim 17, wherein the controller is able to receive a from the first station a request to establish the secured direct link, the request including a first set of communication rates and at least a type of at a supported encryption method, and wherein the controller is further able to generate a response message that includes at least a second set of communication rates and the type of the supported encryption method based on information received from the second station.

20. The apparatus of claim 17, wherein the controller is able to select from the first set of communication rates and the second set of communication rates a subset of communication rate that are supported by the first station and by the second station.

21. The apparatus of claim 17, wherein the controller is able to select an encryption method that is supported by the first station and the second station based on the supported type of the encryption method.

22. The apparatus of claim 18 comprising a key generator to generate pair-wise keys according to the selected encryption method.

23. The apparatus of claim 21, wherein the controller is able to generate two or more response messages that include a subset of communication rates and the pair-wise keys.

24. The apparatus of claim 22, comprising a transmitter to transmit the response messages to the first station and to the second station.

25. A wireless communication system comprising:
an access point that includes a controller to establish a secured direct link between a first station and a second station of wireless local area network by exchanging two or more protocol messages with the first station and the second station.

26. The wireless communication system of claim 24, wherein the controller is able to receive from the first station a request to establish the secured direct link, the request including a first set of communication rates and at least a type of at a supported encryption method, and wherein the controller is further able to generate a response message that includes at least a second set of communication rates and the type of the supported encryption method based on information received from the second station.

27. The wireless communication system of claim 24, wherein the controller is able to select from the first set of communication rates and the second set of communication rates a subset of communication rates that are supported by the first station and by the second station.

28. The wireless communication system of claim 24, wherein the controller is able to select an encryption method that is supported by the first station and the second station based on the supported type of the encryption method.

29. The wireless communication system of claim 25 comprising a key generator to generate pair-wise keys according to the selected encryption method.

30. The wireless communication system of claim 28, wherein the controller is able to generate two or more response messages that include a subset of communication rates and the pair-wise keys.

31. The wireless communication system of claim 29, comprising a transmitter to transmit the response messages to the first station and to the second station.

32. An article comprising: a storage medium, having stored thereon instructions, that when executed, result in:
establishing a secured direct link between a first station and a second station of a wireless local area network by exchanging two or more protocol messages between an access point and the first station and the access point and the second station.

33. The article of claim 31 wherein the instruction of establishing when executed, result in:
receiving from the first station a request to establish the secured direct link, wherein the request includes communication rate information and encryption method information.

34. The article of claim 32, wherein the instruction of establishing when executed, result in:
receiving from the second station a request to establish the secured direct link, wherein the request includes communication rate information and encryption method information.

35. The article of claim 31 wherein the instruction when executed, result in:
sending to the second station a message to establish the secured direct link, wherein the message includes communication rate information of the first station and encryption method information of the first station.
